(19) United States
(12) Patent Application Publication
(10) Pub. No.: US 2004/0118635 A1
(43) Pub. Date: Jun. 24, 2004

(54) Apparatus for evacuating people from a high building in emergency

(76) Inventors: Shin-Shing Sun, Sanmin Chiu (TW); Pei-Chun Sun, Sanmin Chiu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/322,543

(22) Filed: Dec. 19, 2002

(51) Int. Cl. A62B 1/06

(52) U.S. Cl. 182/142; 182/37

(57) ABSTRACT

An apparatus for evacuating people from a high building in emergency includes a car member, a pivotal arm disposed on a top floor of a building, first and second motors disposed on the top floor and controllable with control units, and first, second and third steel ropes. The first rope is connected to the first motor at one end, and is passed over first and second pulleys fitted to the arm and joined to the car member at the other end. The second and the third ropes are connected to the second motor at first ends, respectively passed over third and fourth pulleys fitted to the arm, and passed through respective pairs of guiding rings of the car member and secured to the ground at second ends so that movement the car member is made stable and smooth by the second and the third ropes.

### BACKGROUND OF THE INVENTION

1. Field of the Invention

The present invention relates to an apparatus for evacuating people from a high building in emergency, more particularly an apparatus for evacuating people from a high building on fire, which can provide ride to many people to be evacuated from a high building and in a secure manner with smooth movement.

2. Brief Description of the Prior Art

Many high buildings are built in densely populated areas, especially big cities, for providing more rooms to people with a relatively small land. Should there be fire in multi-floor buildings, fire fighters and rescue men have to use tower ladders of aerial ladder trucks to evacuate people trapped in the buildings. However, with modern buildings being built higher and higher, conventional tower ladders can't reach upper portions of a very high building, e.g. a skyscraper. It is not ideal to rely on helicopters alone in evacuating people from a high building because there might be relatively long distance between the top floor of a high building on fire and a place suitable for people to get off the helicopters.

Therefore, a device used for escaping from a high building on fire was provided, which includes a rope, and a supporting member, which is disposed near a window or balcony of a floor of a building, and to which one end of the rope is fastened. In using the device to escape from a building, the user has to first lash the rope around his/her body so that he/she can be evacuated to the ground outside the building slowly. However, such device has disadvantages as followings:

1. The device is not efficient to use because it can provide a ride to a single person each time. Consequently, people trapped on a floor on fire can't be evacuated fast enough.

2. The user would be made to feel pain or even get injured by that portion of the rope that is tied around his/her because this portion bears the weight of his/her entire body.

3. This device can't be used with an invalid or a child because besides having the rope lashed around the body, the user still has to hold on to the rope and manage to avoid hitting other objects for enough security while being evacuated with this device.

4. Not every person dares to use this device to escape from a building, especially a high building. Therefore, this device has limited use.

### SUMMARY OF THE INVENTION

It is a main object of the present invention to provide an apparatus for evacuating people from a high building in emergency, which can provide ride to many people to be evacuated from a high building, and which includes a pivotal arm disposed on a top floor of a building, guiding steel ropes supported by both the arm and the ground, and a car member, which is can be moved up and down by another steel rope along the guiding steel ropes with the guiding ropes helping it move smoothly.

It is another main object of the present invention to provide an apparatus for evacuating people from a high building in emergency, which has stepping boards fitted to widows of the building for providing people with access to the car member.

It is yet another main object of the present invention to provide an apparatus for evacuating people from a high building in emergency, which has brakes fitted thereto for people in the car member to operate if need be.

It is still another main object of the present invention to provide an apparatus for evacuating people from a high building in emergency with a door and stepping board, which is faced with a building, and which is pivoted between an opened position and a closed one for giving the people easy access and security respectively in evacuating operation.

### BRIEF DESCRIPTION OF THE DRAWINGS

The present invention will be better understood by reference to the accompanying drawings, wherein:

FIG. 1 is a perspective view of the apparatus for evacuating people from a high building according to the present invention,

FIG. 2 is a side view of the apparatus for evacuating people from a high building under operation according to the present invention,

FIG. 3 is another side view of the apparatus for evacuating people from a high building under operation according to the present invention,

FIG. 4 is a view of the brake handle of the apparatus for evacuating people from a high building according to the present invention,

FIG. 5 is a side view of the present apparatus for evacuating people from a high building in the not-in-use position,

FIG. 6 is a view of the brake handle of the apparatus for evacuating people from a high building under operation according to the present invention,

FIG. 7 is a perspective view of a car of the apparatus for evacuating people from a high building of the second embodiment,

FIG. 8 is a side view of the brake handle of the apparatus for evacuating people from a high building of the second embodiment,

FIG. 9 is a side view of the brake handle of the apparatus for evacuating people from a high building under operation according to the second embodiment,

FIG. 10 is a side view of the apparatus for evacuating people from a high building in use according to the second embodiment,

FIG. 11 is a view of the car of the apparatus for evacuating people from a high building in closed position according to the second embodiment,

FIG. 12 is a view of the car of the apparatus for evacuating people from a high building in opened position according to the second embodiment,

FIG. 13 is a perspective view of the apparatus for evacuating people from a high building in the third embodiment,

FIG. 14 is a perspective view of the apparatus for evacuating people from a high building in the fourth embodiment; and,

FIG. 15 is a perspective view of the apparatus for evacuating people from a high building in the fifth embodiment.

### DETAILED DESCRIPTION OF THE PREFERRED EMBODIMENTS

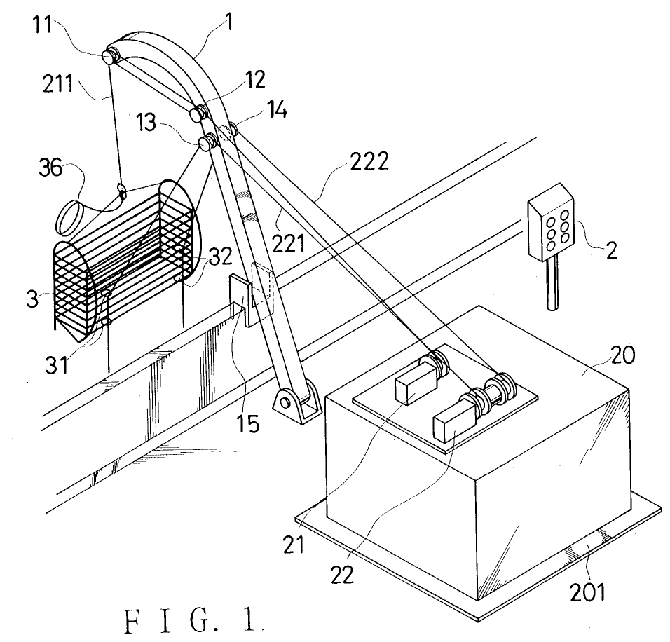

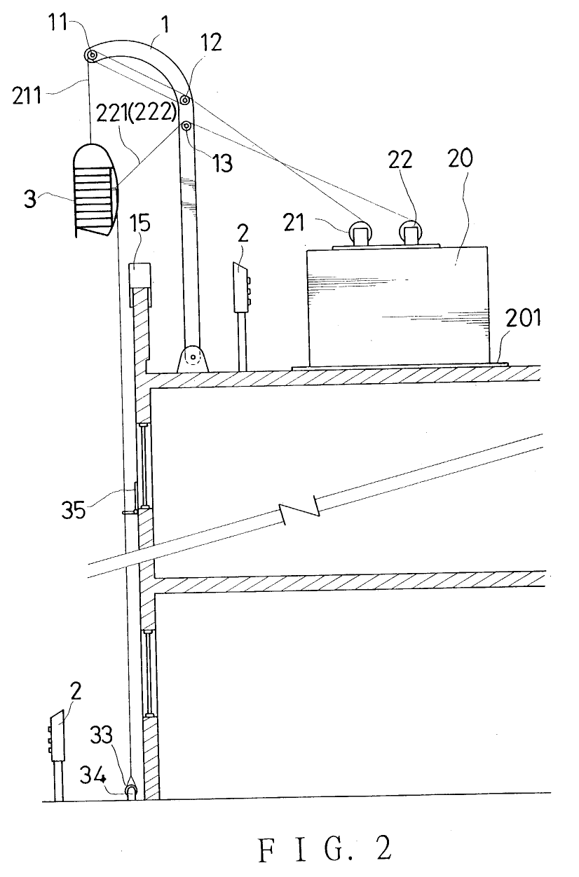

Referring to FIGS. 1, 2, and 3, an apparatus for evacuating people from a high building according to the present invention includes an arm 1, control units 2, and a car member 3.

The arm 1 is pivoted to a top floor of a building at a lower end thereof. Fitted to the arm 1 are a first pulley 11, a second pulley 12, third, and fourth pulleys 13, and 14. A supporting member 15 is disposed on the wall of the top floor so that the arm 1 can be supported in a tilted in-use position with an upper end thereof projecting beyond the wall of the top floor.

The control units 2 are provided on the ground, the top floor and each floor of the building for controlling movement of first and second motors 21, 22, which are disposed on top of a big water tank 20 disposed on the top floor; water is contained in the water tank 20. A board 201 is provided on the bottom of the water tank 20, and fixed to the top floor.

A first steel rope 211 is connected to the first motor 21 at one end, and passed over both the first and the second pulley 11, 12, and connected to the car member 3 at the other end. Second and third steel ropes 221, 222 are connected to the second motor 22 at first ends, and passed over the third, and the fourth pulleys 13, and 14 respectively.

The car member 3 has a curved shape on a side that is faced with the building, and several safety ropes 36 provided on an upper portion thereof. Two pairs of guiding rings 31, 32 are provided on an inner side of the car member 3. The second and the third steel ropes 221, 222 are passed through respective pairs of guiding rings 31, 32 after they are passed over respective pulleys 13, 14. Hooks 33 are joined to other ends of the second and the third steel ropes 221, 222, and the hooks 33 are hooked onto fastening elements 34, which are fixed to the ground. Thus, the steel ropes 221, 222 are fixed in position to be used as guiding means for tip and down movement of the car member 3 when the present apparatus is used.

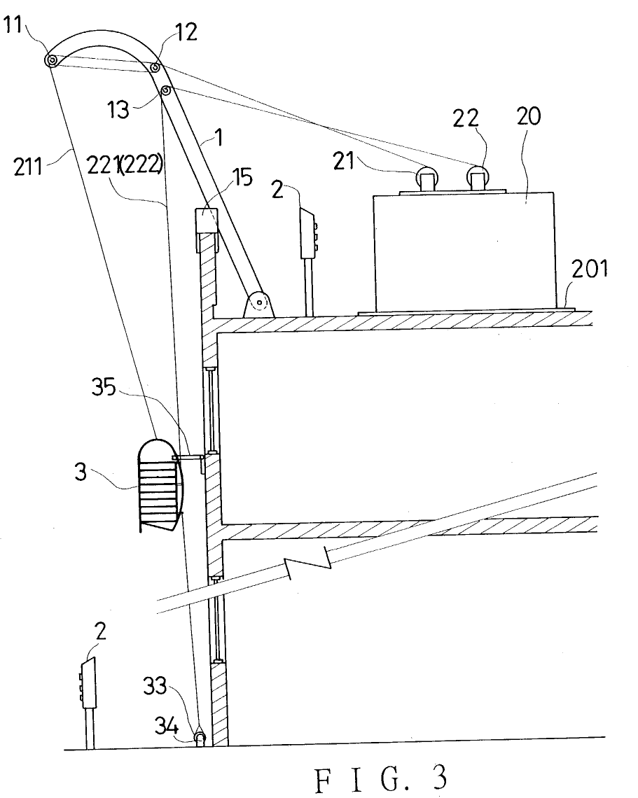

Stepping-members 35 are provided on windows of floors of the building so that the stepping-members 35 can be connected to the car member 3 for allowing people inside the building to walk into the car member 3 easily when the car member 3 is moved to the front of the windows. The stepping-members 35 can be pivotally connected to the frames of the windows, and made to have “L” shape. The L-shaped stepping-members 35 are usually positioned upright, and will be forced to pivot to a laid-down position when the car member hits the short sides thereof during the course of downward movement. The long sides of the L-shaped stepping-members 35 will be connected to the car member 3 when the car member 3 is stopped in front of corresponding windows thereof, as shown in FIG. 3.

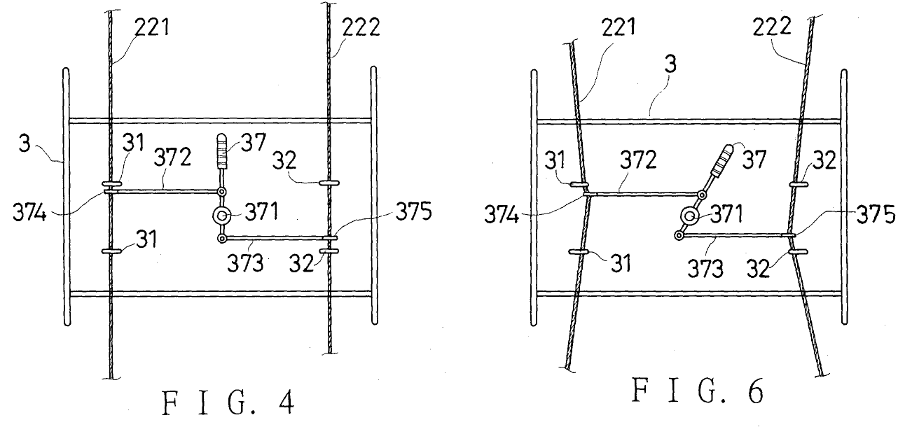

Referring to FIGS. 4, and 6, there is a brake fitted to the car member 3, which includes a brake lever 37, a pivotal element 371, connecting rods 372, 373, which have respective rings 374, and 375 connected to outward ends thereof. The second and the third steel ropes 221, 222 are passed through the rings 374, and 375 respectively after they are passed through an upper one of respective pairs of guiding rings 31, 32. The pivotal element 371 is connected to an inner side of the car member 3. The brake lever 37 is joined to the pivotal element 371 so that it can be turned. Inward ends of the connecting rods 372, 373 are connected to different positions of the brake lever 37 that are beside the pivotal element 371. Therefore, the rings 374, 375 will not interfere with movement of the car member 3 along the steel ropes 221, 222 when the lever 37 is not moved by the riders, and stays upright, and will force the steel ropes 221, 222 to bend when the lever 37 is pivoted to a tilted action position, as shown in FIG. 6, thus making the car member 3 slow down or stop.

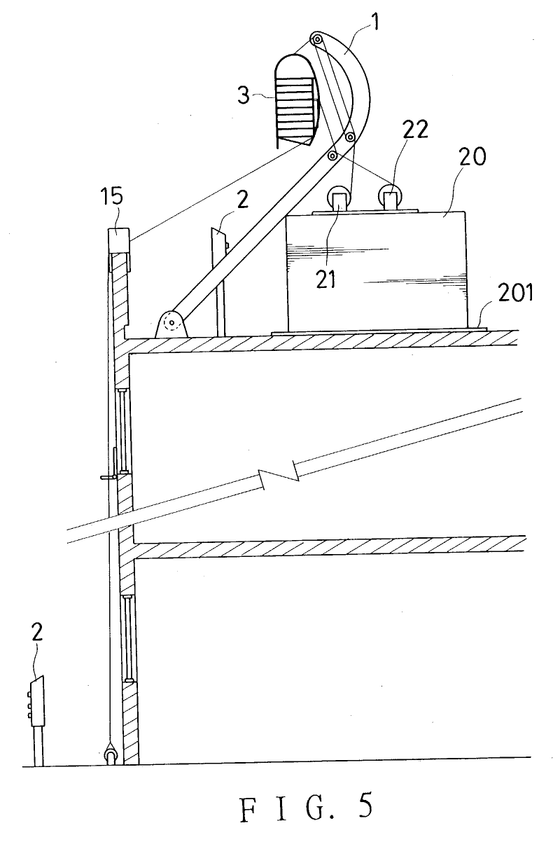

When the present apparatus is not used, referring to FIG. 5, the arm 1 is pivoted away from the wall of the building, and leant against the water tank 20. When there is emergency, such as a fire, giving rise to the need for the present apparatus, the arm 1 is pivoted away from the water tank 20, and leant against the supporting member 15. Then, the second motors 22 are actuated so that the other ends of the steel ropes 221, 222 are allowed to move down to the ground. The hooks 33 are hooked onto the fastening elements 34 fixed to the ground so that the steel ropes 221, 222 are steadily positioned substantially vertical in front of the building. Afterwards, people on the top floor get aboard, and the first motor 21 is actuated to control the first steel rope 211 so that the car member 3 moves down slowly and smoothly along the steel ropes 221, 222. The car member 3 can be stopped at other floors of the building for allowing people to get aboard the car member 3 by means of operating the control unit 2; the stepping members 35 are moved to the laid down position forming a bridge between the car member 3 and the building for people to get aboard easily and more safely; when the car member 3 is being moved up, it will hit the long sides of the L-shaped stepping members 35 to move the same from the laid down position to the upright position. Furthermore, people riding in the car member 3 can have the safety ropes 36 tied around them.

Should the car member 3 run out of control while it is being moved up and down in the evacuation operation, the brake lever 37 is pulled for the rings 374, 375 to force the steel ropes 221, 222 to bend, thus making the car member 3 slow down or stop.

The second embodiment:

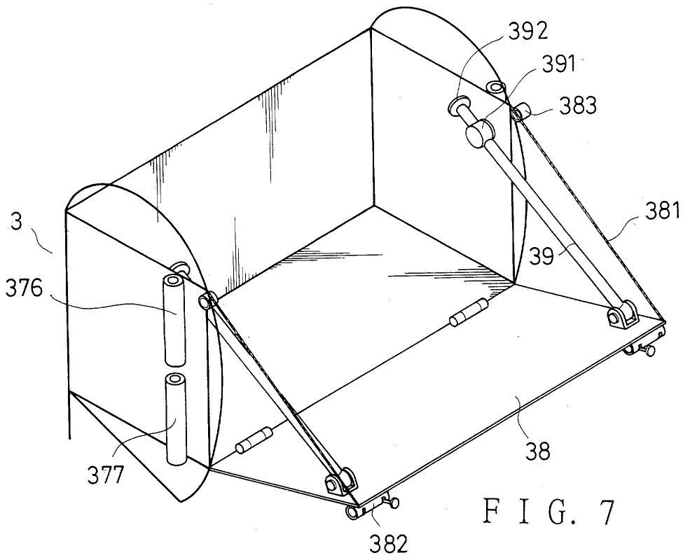

Referring to FIG. 7, a car member 3 of the second embodiment is made of solid boards, and has a pairs of upper and lower guiding tubes 376, 377 on each of the lateral wall portions thereof A door and stepping board 38 is pivoted to a bottom of the car member 3. There are steel ropes 381, 381, which are connected to the door and stepping board 38 and upper parts of the lateral wall portions at two ends, for limiting the position of the door and stepping board 38 when the door and stepping board 38 is opened. Locking elements are provided to two lateral sides of the car member 3; each of the locking elements includes a movable male part 382 fixed to the door and stepping board 38, and a stationary female part 383 connected to the lateral wall portions. The movable male parts 382 are engaged with respective stationary female parts 383 to prevent the door and stepping board 38 from moving relative to the lateral wall portions when the door and stepping board 38 is closed. In addition, limiting rods 39, 39 are provided to two lateral sides of the car member 3; each of the limiting rods 39, 39 are pivoted to the inner side of the door and stepping board 38 at first ends, and slidably passed through respective pivotal units 391 at the second ends. The pivotal units 391 are arranged on inner sides of respective lateral wall portions of the car member 3. The second ends of the limiting rods 39, 39 are formed with stopping blocks 392, 392 for preventing the limiting rods 39 from falling off the pivotal units 391.

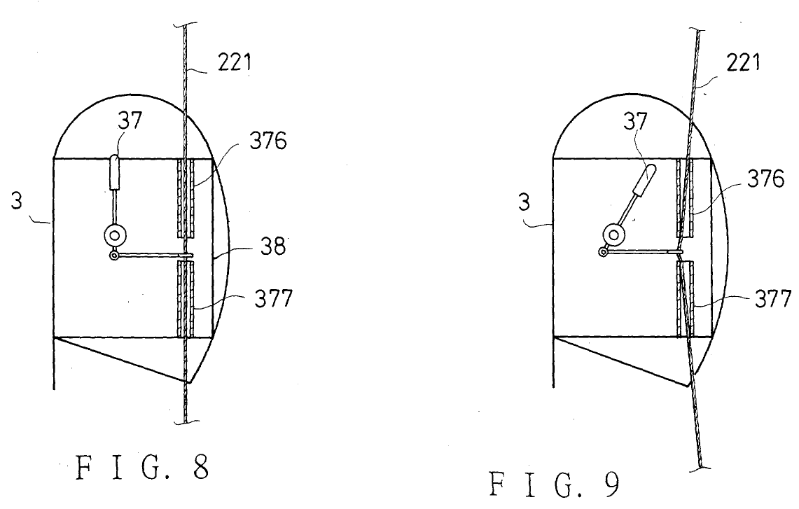

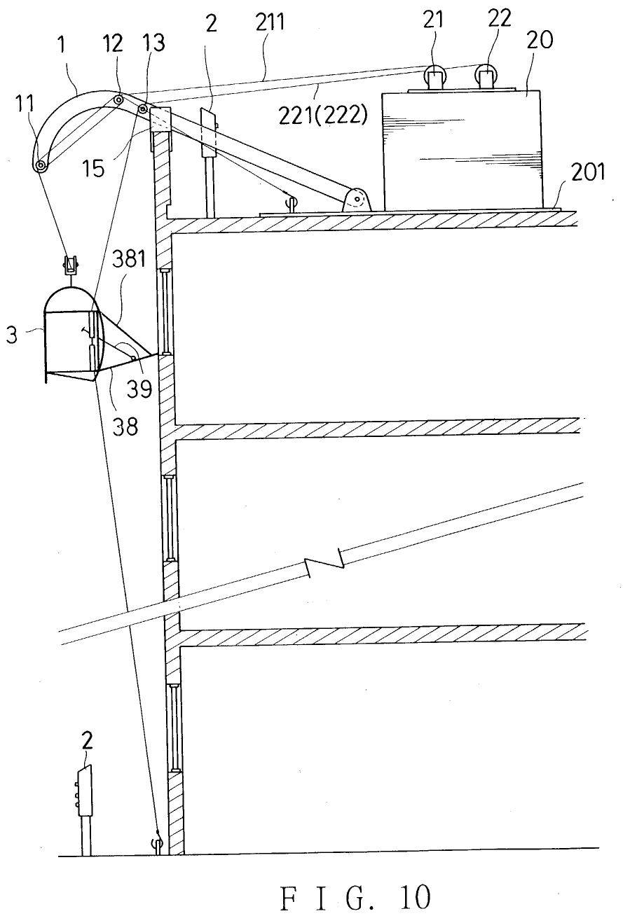

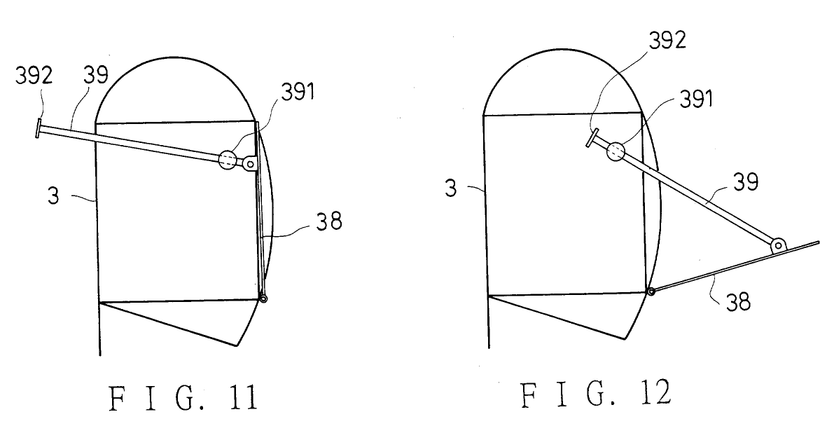

Referring to FIGS. 8, and 9, the steel ropes 221, 222 are passed through respective pairs of upper and lower guiding tubes 376, 377 to be used as a guiding means like the first embodiment. Two brakes are joined to the inner sides of the lateral wall portions of the car member 3. Relatively similar to the brake of the first embodiment, each of the brakes has a brake lever 37, a pivotal unit, and a connecting rod having a ring at one end. The rings are disposed between corresponding pairs of upper and lower guiding tubes 376, 377, and the steel ropes 221, 222 are passed through corresponding ones of the rings. The brake levers 37 are passed through the pivotal units, which are arranged on the lateral wall portions, and joined to the connecting rods so that they can be operated to cause the car member 3 to stop or slow down, as shown in FIG. 9.

When the present apparatus is used, and when the car member 3 is stopped at a floor, the door and stepping board 38 is opened to become a bridge between the car member 3 and the building for providing people with easy access to the car member 3. Should the steel ropes 381 be broken, as shown in FIG. 12, the limiting rods 39 can work together with the pivotal units 391 to prevent the door and stepping board 38 from pivoting down beyond a useful position capable of providing people with access to the car member 3.

The Third Embodiment:

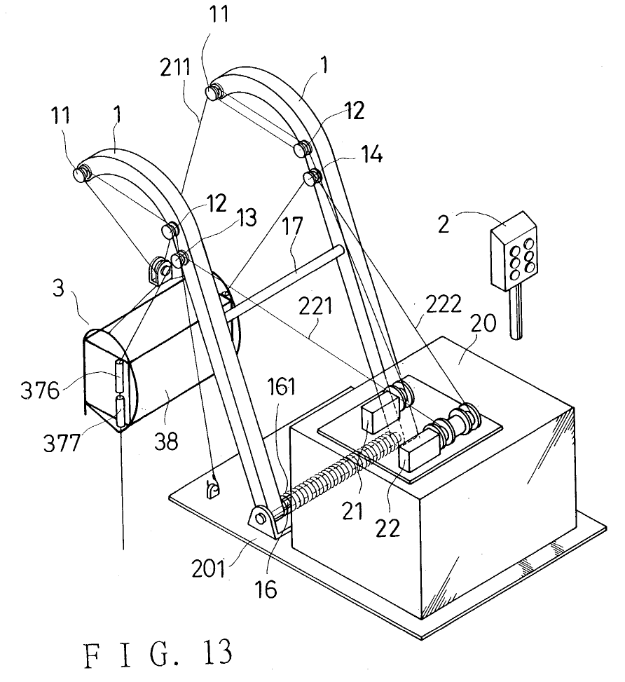

The board 201, to which the water tank 20 is fixedly joined, is fixedly disposed on the top floor of a building. Arm 1 can be pivotally connected to pivotal members (not numbered) fixedly joined to the board 201, and can be made of several curved rod parts connected parallel to each other or with an angle in between. Referring to FIG. 13, the arm 1 of the third embodiment includes two lateral arm parts, a horizontal lower connecting rod 16, and an upper connecting rod 17. The upper connecting rod 17 is connected to middles of the arm parts. The lower connecting rod 16 is turnably supported with the pivotal members fixed to the board 201, and is connected to lower ends of the arm parts; owing to both the lower connecting rod 16 and the upper connecting rod 17, the arm parts can't be forced to move closer to each other by steel ropes to be detailed hereinafter. There is a spring 161 disposed between the arm parts, through which the lower connecting rod 16 is passed, for helping the arm 1 to be pivoted to the in-use position. There are a first pulley 11, a second pulley 12, and a third pulley 13 (14) fitted to each of the arm parts. First steel ropes 211 are connected to the first motor 21, and passed over the pulleys 11, 12 of respective arm parts to be connected to car member 3. Steel ropes 221, 222 are connected to the second motors 22 at first ends, and passed over respective pulleys 13, and 14 to be passed through guiding tubes 376, 377 of car member 3 and secured to the ground at second ends.

The Fourth Embodiment:

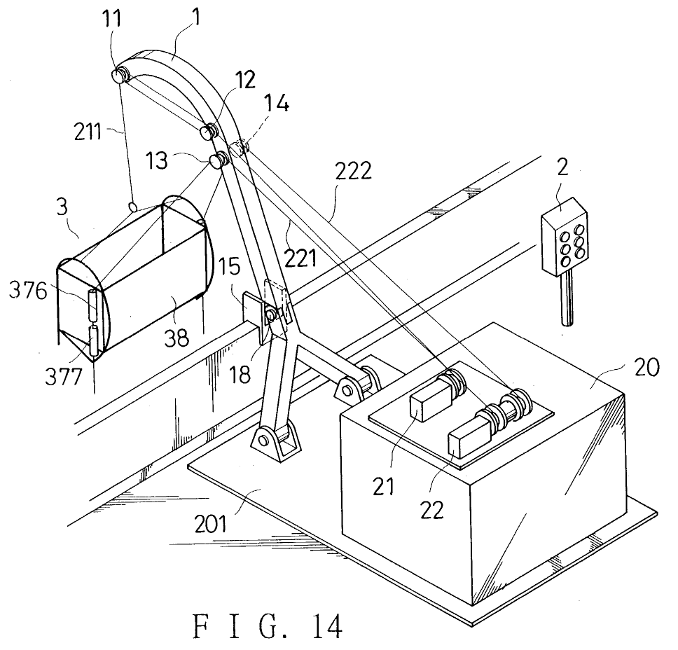

Referring to FIG. 14, arm 1 is made to have a substantially Y shape, and is pivotally connected to pivotal members fixed to the board 201 in inverted position. The arm 1 is equipped with pulleys 11, 12, 13, 14, and the pulleys are connected to car member 3 in the way used in the first two embodiments. The arm 1 is preferably made to consist of two separable parts, which are joined together with screws 18, so that it can be transported and stored more easily.

The Fifth Embodiment:

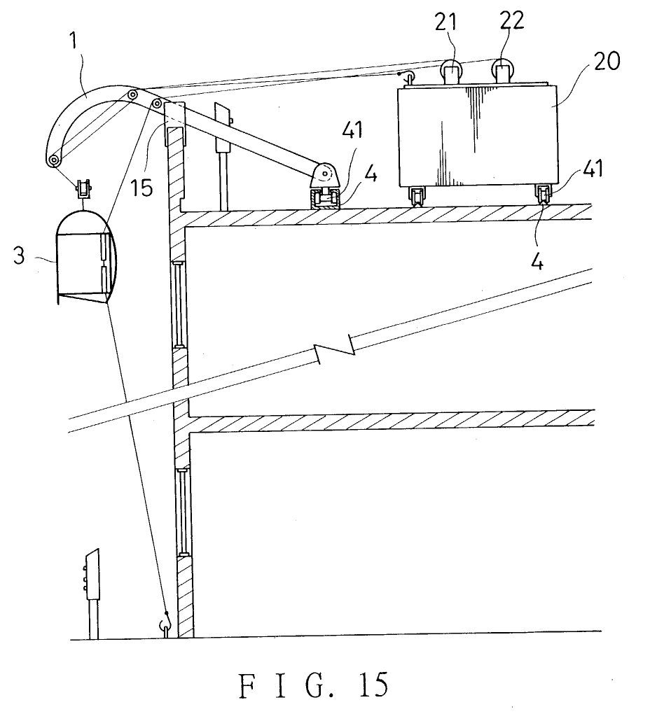

Referring to FIG. 15, water tank 20 and pivotal members (not numbered), to which lower ends of the arm is pivoted, can be equipped with wheels 41 on the bottoms, and rails 41 can be disposed on the top floor of a building. Thus, the water tank 20, to which motors 21, 22 are fitted, and the arm 1 can be moved along the rails 4 to suitable positions in evacuation operation.

From the above description, it can be understood that the present apparatus for evacuating people from a high building in emergency has desirable features as following:

1. The present apparatus can provide a ride to many people each trip therefore people trapped on a building on fire can be evacuated in time.

2. The car member of the present apparatus can provide a ride to invalids, and persons in a coma or injured, and allows them to sit or lie therein during the journey to the ground. Therefore, the present apparatus has relatively wide use.

3. The steel ropes passed through the guiding rings (tubes) of the car member help the car member move up and down smoothly without possibility of shaking. Therefore, people riding in the car member are given a secure feeling.

4. The present apparatus is equipped with stepping boards easily usable as bridges between the car member and the building therefore people have easy and safe access to the car member.

5. The water tank, in which water is contained, is relatively big in size therefore the motors are supported steadily.

6. Control units 2 are available on the top floor, each of other floors, and the ground for allowing people in the building and rescue men to operate in emergency therefore the present apparatus is convenient to use.

7. Brake is provided to the present apparatus therefore people in the car member can make the car member to stop or slow down easily with the brake in case the motors or the steel ropes fail to work properly giving rise to movement of the car member getting out of control in evacuating operation.

8. The car member 3 has a curved shape on the side facing the building so that it can't be stopped with objects that project from the building in evacuating operation.

9. The water tank and the pivotal members, to which lower ends of the arm is pivoted, are equipped with wheels and rails. Therefore, the water tank and the arm can be moved to suitable positions in evacuation operation. In other words, the range of evacuation operation includes all windows of a building with the present evacuation apparatus.

What is claimed is:

1. An apparatus for evacuating people from a high building in emergency, comprising
a plurality of control units;
a car member provided for people to ride on; the car member having two pairs of holed guiding members joined thereto;
a pivotal arm disposed on a top floor of a building; the arm being capable of pivoting to an in-use position leaning against a wall of the top floor; the pivotal arm having first, second, third, and fourth pulleys fitted thereto;
first and second motors disposed on the top floor and controllable with the control units;
a first steel rope connected to the first motor at one end; other end of the first steel rope being passed over the first and the second pulleys, and joined to the car member; and,
second and third steel ropes; the second and the third steel ropes being connected to the second motor at first ends, passed over respective ones of the third and the fourth pulleys, and passed through respective pairs of gliding members at second ends; the second ends of the second and the third steel ropes being secured to a ground adjacent to the building so that the car member can be moved up and down along the second and the third steel ropes in front of the building for evacuating people from the building.

2. The apparatus for evacuating people from a high building in emergency as claimed in claim 1, wherein the car member has a stepping board fitted to each of corresponding widows of the building for providing people with access to the car member.

3. The apparatus for evacuating people from a high building in emergency as claimed in claim 1, wherein the car member has safety ropes connected thereto for people riding in the car member to the around them with.

4. The apparatus for evacuating people from a high building in emergency as claimed in claim 1, wherein supporting members are fitted to the wall of the top floor of the building for the arm to lean against when the arm is pivoted to the in-use position.

5. The apparatus for evacuating people from a high building in emergency as claimed in claim 1, wherein the motors are fixedly disposed on top of a water tank.

6. The apparatus for evacuating people from a high building in emergency as claimed in claim 1, wherein the control units are arranged on the top floor, each of other floors of the building, and the ground respectively.

7. The apparatus for evacuating people from a high building in emergency as claimed in claim 1, wherein the car member has a curved shape on a side thereof that is faced with the building.

8. The apparatus for evacuating people from a high building in emergency as claimed in claim 1, wherein the car member has a plurality of brakes fitted thereto.

9. The apparatus for evacuating people from a high building in emergency as claimed in claim 1, wherein the arm is comprised of a single rod part.

10. The apparatus for evacuating people from a high building in emergency as claimed in claim 1, wherein the arm is comprised of a plurality of rod parts.

11. The apparatus for evacuating people from a high building in emergency as claimed in claim 1, wherein the arm is made to have a substantially Y shape.

12. The apparatus for evacuating people from a high building in emergency as claimed in claim 1, wherein the car member has a door and stepping board, which can be pivoted between a substantially vertical closed position and a substantially laid-down opened position.

13. The apparatus for evacuating people from a high building in emergency as claimed in claim 5, wherein a bottom of the water tank is fixedly connected to board fixed to the top floor.

14. The apparatus for evacuating people from a high building in emergency as claimed in claim 5, wherein the arm is pivoted to a pivotal member, and the water tank and the pivotal member are equipped with wheels on bottoms, and disposed on respective rails to be mobile.

15. The apparatus for evacuating people from a high building in emergency as claimed in claim 10, wherein the plural rod parts of the arm have a plurality of connecting rods connected thereto.

16. The apparatus for evacuating people from a high building in emergency as claimed in claim 15, wherein one of the connecting rods is connected to lower ends of the rod parts and positioned horizontal, and is passed through a spring.

17. The apparatus for evacuating people from a high building in emergency as claimed in claim 11, wherein the Y-shaped arm is made to consist of a plurality of separable parts capable of being joined together with screws.

18. The apparatus for evacuating people from a high building in emergency as claimed in claim 12, wherein the car member is provided with two locking elements, each of which includes a movable male part fixed to the door and stepping board, and a stationary female part connected to the lateral wall portions; the movable male parts being engaged with respective stationary female parts to prevent the door and stepping board from being opened accidentally when the door and stepping board is in the closed position.

19. The apparatus for evacuating people from a high building in emergency as claimed in claim 12, wherein the car member has steel ropes each connected to both a lateral side of the car member and the door and stepping board for limiting movement of the door and stepping board when the door and stepping board is opened.

20. The apparatus for evacuating people from a high building in emergency as claimed in claim 12, wherein the car member has limiting rods, each of which is pivoted to an inner side of the door and stepping board at a first end, and slidably passed through a pivotal unit at a second end; the pivotal units being arranged on respective lateral inner sides of the car member; the second ends of the limiting rods being formed with stopping blocks for preventing the limiting rods from falling off the pivotal units so that range of movement of the door and stepping board is limited when the door and stepping board is being opened.
